(19) United States
(12) Patent Application Publication
(10) Pub. No.: US 2016/0004620 A1
(43) Pub. Date: Jan. 7, 2016

(54) DETECTION APPARATUS, DETECTION METHOD, AND RECORDING MEDIUM

(71) Applicant: HITACHI, LTD., Chiyoda-ku, Tokyo (JP)

(72) Inventor: Masanobu OHIKE, Tokyo (JP)

(21) Appl. No.: 14/770,582

(22) PCT Filed: May 16, 2013
(86) PCT No.: PCT/JP2013/063675

§ 371 Date: Aug. 26, 2015

(51) Int. Cl. G06F 11/34

(52) U.S. Cl. CPC G06F 11/3419

(57) ABSTRACT

A detection apparatus comprises an acquisition module configured to acquire a plurality of time-series data on a detection target; a setting module configured to set, based on a first time period in which the plurality of time-series data acquired by the acquisition module exist, a plurality of second time periods as inspection ranges; a selection module configured to select a combination of two or more time-series data from among the plurality of time-series data; and a calculation module configured to calculate a correlation coefficient in each of the plurality of second time periods set by the setting module for the combination of two or more time-series data selected by the selection module.

### BACKGROUND OF THE INVENTION

This invention relates to a detection apparatus, a detection method and a recording medium for detecting a correlation.

In recent years, there have been increasing expectations to extract correlated data from among various types of data generated from an information technology (IT) system and to utilize those data for a business operation. Among those, failure sign detection is attracting attention, in which a correlation detection technology is utilized to detect a silent failure of the IT system in advance so that the silent failure can be handled.

Hitherto, based on various types of data generated from the IT system, various types of statistical analysis methods are used to extract a pattern of data and detect a correlation among a plurality of data, and a sign is detected with the use of a detection result. For example, in JP 2009-187293 A, there is proposed a method of detecting a sign of a failure based on a change in correlation among a plurality of time-series data. In the technology of JP 2009-187293 A, the correlation is detected in a single time period.

In general, one time-series data and another time-series data are correlated with each other in a long-term data range or a short-time data range depending on the type of time-series data. Specifically, the long-term correlation includes a correlation between service process response time and a memory utilization rate for example, and the short-term correlation includes a correlation between the service process response time and a central processing unit (CPU) utilization rate for example.

However, the above-mentioned related art detects a single correlation from a given combination of time-series data, but has only one detection pattern for detecting a sign of a given phenomenon. Therefore, there has been a problem in that there is a risk that reliability of the sign detection is lowered, and a sign is overlooked as a result.

### SUMMARY OF THE INVENTION

It is an object of this invention to achieve an increase in number of time periods for detecting a correlation.

An aspect of the invention disclosed in this application is a detection apparatus, comprising: an acquisition module configured to acquire a plurality of time-series data on a detection target; a setting module configured to set, based on a first time period in which the plurality of time-series data acquired by the acquisition module exist, a plurality of second time periods as inspection ranges; a selection module configured to select a combination of two or more time-series data from among the plurality of time-series data; and a calculation module configured to calculate a correlation coefficient in each of the plurality of second time periods set by the setting module for the combination of two or more time-series data selected by the selection module.

According to the representative embodiment of this invention, it is possible to achieve an increase in number of time periods for detecting a correlation. Other objects, configurations, and effects than those described above are clarified by the following description of an embodiment.

### BRIEF DESCRIPTION OF THE DRAWINGS

FIG. 1 is an explanatory diagram for illustrating examples of calculation of a correlation coefficient.

FIG. 2 is an explanatory diagram for illustrating an example of storage of data when there is a correlation.

FIG. 3 is an explanatory diagram for illustrating an example of storage of data when there is no correlation.

FIG. 4 is an explanatory diagram for illustrating an example of assignment of the time-series data to a sign detection process.

FIG. 5 is a block diagram illustrating a hardware configuration example of the detection apparatus.

FIG. 6 is a block diagram illustrating a functional configuration example of the detection apparatus.

FIG. 7 is an explanatory diagram for showing an example of contents stored in an intermediate value DB.

FIG. 8 is an explanatory diagram for showing an example of generation of the intermediate value.

FIG. 9 is an explanatory diagram for showing an example of the summarization process.

FIG. 10 is an explanatory diagram for showing the time-series data before and after the smoothing by the moving average process.

FIG. 11 is an explanatory diagram for showing an example of the time correction process.

FIG. 12 is an explanatory diagram for showing an example of contents stored in the correlation information DB.

FIG. 13 is an explanatory diagram for showing an example of contents stored in the non-correlation information DB.

FIG. 14 is an explanatory diagram for showing an example of the regression line.

FIG. 15 is an undirected graph for showing an example of whether or not the time-series data are correlated.

FIG. 16 is an explanatory diagram for illustrating an example of assignment of the combination of correlated time-series data shown in FIG. 15 to the sign detection process.

FIG. 17 is an explanatory diagram for illustrating an example of a sign detection template registration screen.

FIG. 18 is an explanatory diagram for illustrating an example of an operation-at-correlation-detection setting screen.

FIG. 19 is an explanatory diagram for illustrating an example of a correlation detection screen.

FIG. 20 is an explanatory diagram for illustrating an example of a correlation detection screen.

FIG. 21 is an explanatory diagram for illustrating an example of a correlation detection result reference screen.

FIG. 22 is an explanatory diagram for illustrating an example of a correlation detection result reference screen.

FIG. 23 is an explanatory diagram for illustrating an example of a system monitoring screen.

FIG. 24 is a flowchart for illustrating an example of a process procedure of detecting the correlation, which is to be executed by the detection apparatus.

FIG. 25 is a flowchart for illustrating the detailed process procedure example of the correlation detection process (Step S2402) illustrated in FIG. 24.

FIG. 26 is a flowchart for illustrating the detailed process procedure example of the time correction process (Step S2508) illustrated in FIG. 25.

FIG. 27 is a flowchart for illustrating a detailed process procedure example of the determination process (Step S2403) illustrated in FIG. 25.

FIG. 28 is a flowchart for illustrating a detailed process procedure example of sign detection, which is to be executed by the detection apparatus.

### DETAILED DESCRIPTION OF THE PREFERRED EMBODIMENTS

<Example of Sign Detection>

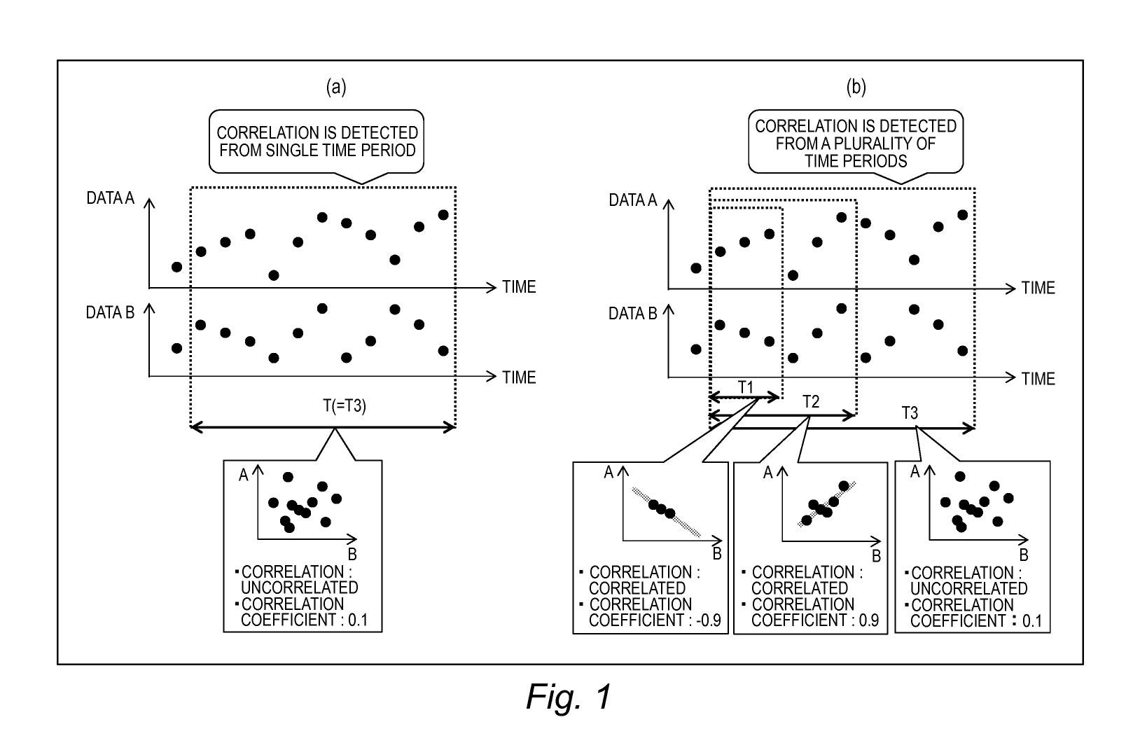

First, referring to FIG. 1 to FIG. 4, a description is given of an example of sign detection according to an embodiment mode of this invention. It should be noted that in this embodiment mode, time-series data refers to a set of observed values that have been observed in a given time period. The time-series data is sometimes simply referred to as “data”.

FIG. 1 is an explanatory diagram for illustrating examples of calculation of a correlation coefficient. Part (a) of FIG. 1 is an illustration of an example in which a correlation coefficient is calculated when a single time period is set as an inspection range, and part (b) of FIG. 1 is an illustration of an example in which correlation coefficients are calculated when a plurality of time periods are set as inspection ranges. In this case, data A and data B are time-series data for which the correlation coefficient is to be calculated. For example, the data A is a CPU utilization rate of a computer system as a monitoring target, and the data B is latency of the computer system.

In part (a) of FIG. 1, it is judged in a single time period T that there is no correlation, whereas in part (b) of FIG. 1, it is judged in a plurality of time periods T1 to T3 whether or not there is a correlation. It is assumed that it is judged that there is a correlation in each of the time periods T1 and T2. It should be noted that the time period T of part (a) of FIG. 1 is the same as the time period T3 of part (b) of FIG. 1. In this manner, it is judged that there is no correlation when only the correlation in the time period T is observed, but by observing the correlations in the plurality of time periods, it is possible to detect that there is a correlation in each of the time periods T1 and T2, and hence a probability that a correlation is overlooked is reduced. It is therefore possible to achieve enhancement in reliability of the sign detection.

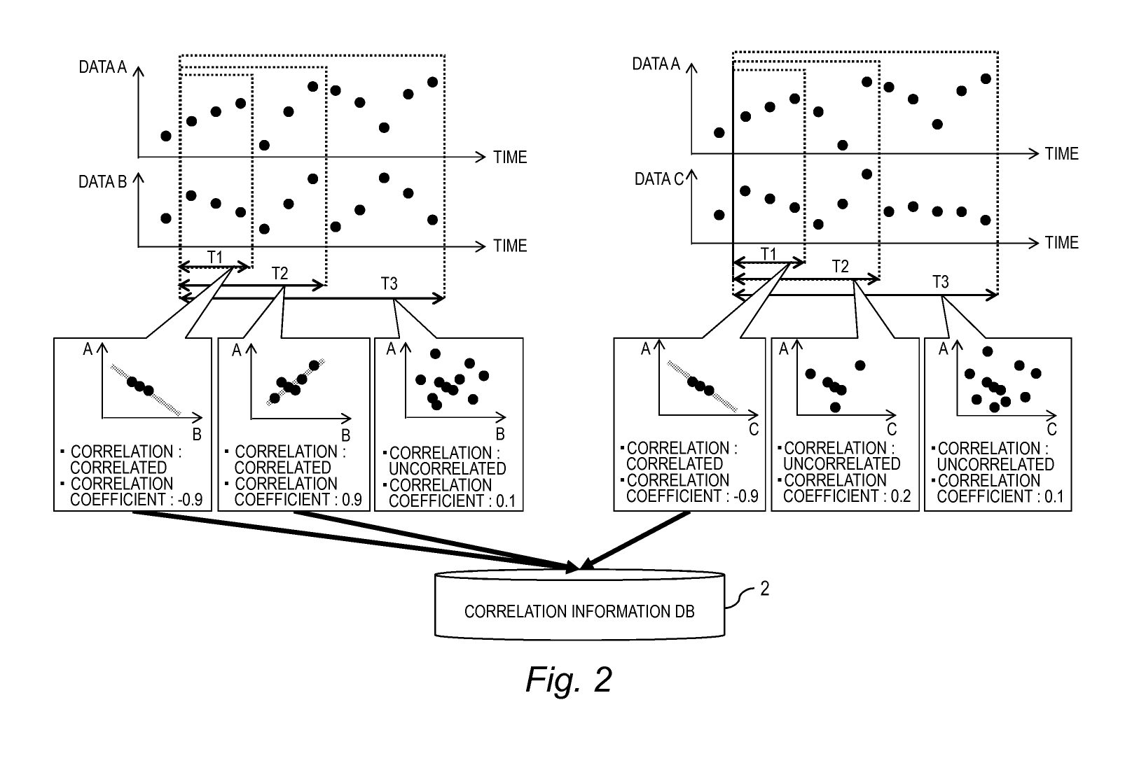

FIG. 2 is an explanatory diagram for illustrating an example of storage of data when there is a correlation. A combination of correlated time-series data is stored in a correlation information database (DB) 2 in association with a time period in which the correlation is observed. For example, for the data A and B, combinations of time-series data in the time periods T1 and T2 are stored, and for the data A and data C, a combination of time-series data in the time period T1 is stored. In this manner, it is possible to confirm which of the combinations of time-series data has a correlation in which of the time periods by referring to the correlation information DB 2.

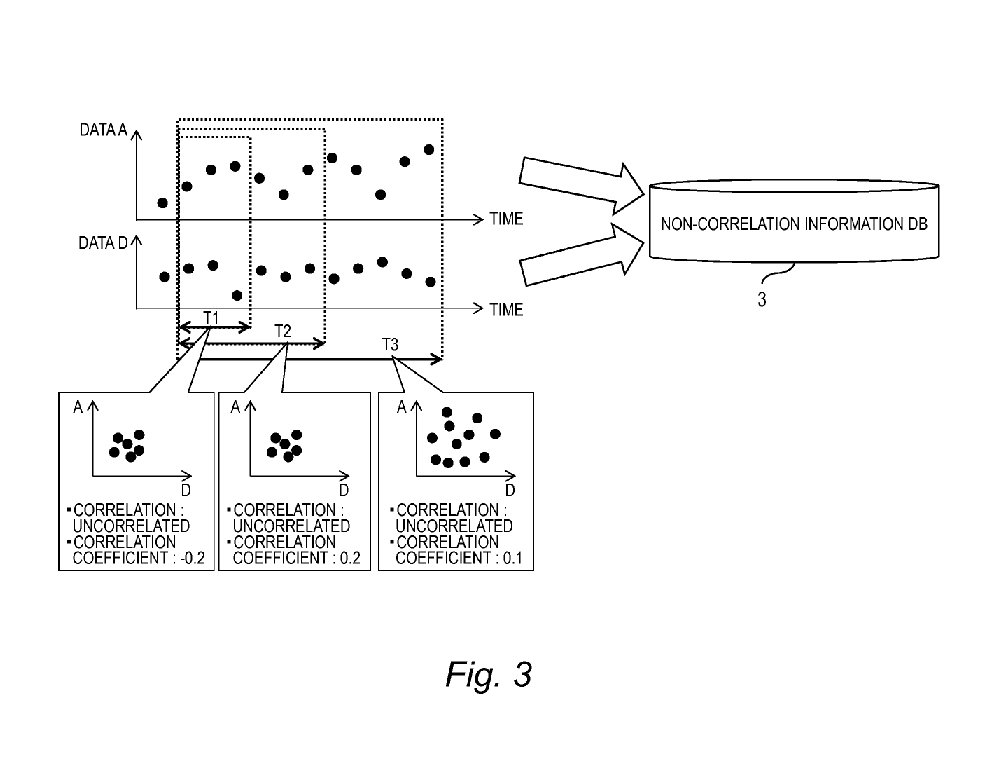

FIG. 3 is an explanatory diagram for illustrating an example of storage of data when there is no correlation. A combination of uncorrelated time-series data is stored in a non-correlation information DB 3. In the example of FIG. 3, a combination of the data A and data D is judged to have no correlation in any of the time periods T1 to T3, and hence the combination of the data A and D is stored in the non-correlation information DB 3. In this manner, it is possible to confirm which of the combinations of time-series data has no correlation by referring to the non-correlation information DB 3.

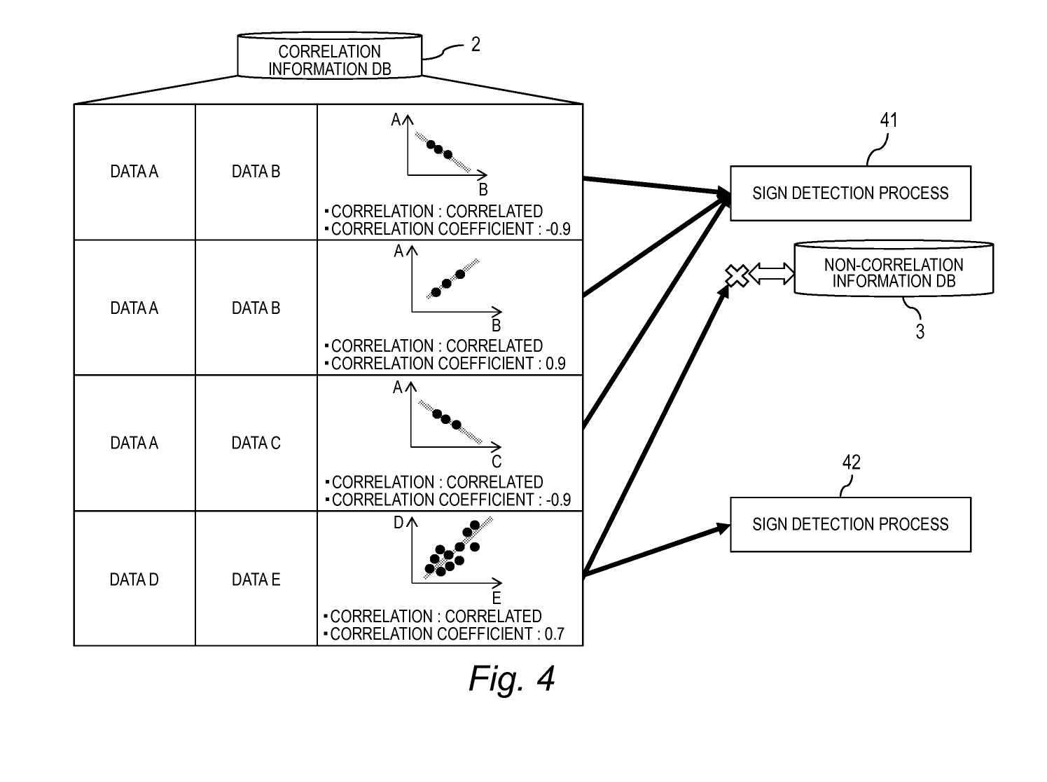

FIG. 4 is an explanatory diagram for illustrating an example of assignment of the time-series data to a sign detection process. The sign detection process is a process or a thread of detecting a sign of a failure that may occur in the monitoring target (hereinafter simply referred to as “process”). The sign detection process is implemented by an existing program. To the sign detection process, the combination of time-series data judged to have a correlation is assigned. Specifically, for example, the combination of time-series data stored in the correlation information DB 2 is assigned to the sign detection process. For example, the data A and B are correlated, and are therefore assigned to a sign detection process 41. In this manner, the sign detection process 41 can use the data A and B to detect a sign of a failure that may occur in the monitoring target.

Further, in the example of FIG. 4, the data A and C are also correlated, and are therefore assigned to the sign detection process. In this case, the data A and C are assigned to the sign detection process 41, to which the data A and B are assigned. In other words, the data A and B and the data A and C share the data A, and hence by assigning those combinations to the same sign detection process 41, it is possible to access the data A through a single process, and hence it is possible to achieve more efficient sign detection processing.

Further, in a similar manner, the data D and data E are correlated, and are therefore assigned to the sign detection process. The data D and E are assigned to a sign detection process 42. The sign detection process 42 is different from the sign detection process 41, to which the data A, B, and C are assigned. Specifically, for example, it is found by referring to the non-correlation information DB 3 that there is no correlation between the data A and the data D, and hence the data A and the data D are never used in the same process. Therefore, pieces of data that are uncorrelated are assigned to different processes. In this manner, it is possible to achieve a load balance between the sign detection process 41 and the sign detection process 42. Further, by executing the sign detection process 41 and the sign detection process 42 in parallel, it is possible to achieve an increase in speed of the sign detection processing, and to achieve early detection of a failure.

<Hardware Configuration Example of Detection Apparatus>

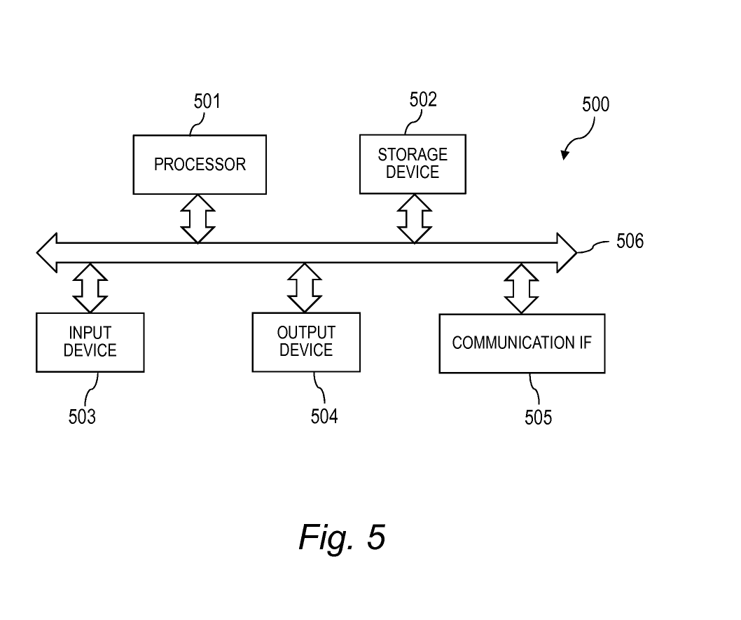

FIG. 5 is a block diagram illustrating a hardware configuration example of the detection apparatus. The detection apparatus 500 includes a processor 501, a storage device 502, an input device 503, an output device 504, and a communication interface (communication IF) 505. The processor 501, the storage device 502, the input device 503, the output device 504, and the communication IF 505 are connected to one another by a bus. The processor 501 controls the detection apparatus 500. The storage device 502 serves as a work area of the processor 501. The storage device 502 is a recording medium which stores various programs and data. The storage device 502 can be, for example, a read-only memory (ROM), a random access memory (RAM), a hard disk drive (HDD), or a flash memory. The input device 503 inputs data. The input device 503 can be, for example, a keyboard, a mouse, a touch panel, a ten-key pad, or a scanner. The output device 504 outputs data. The output device 504 can be, for example, a display or a printer. The communication IF 505 couples to a network to transmit and receive data. Now, a description is given of an embodiment of this invention.

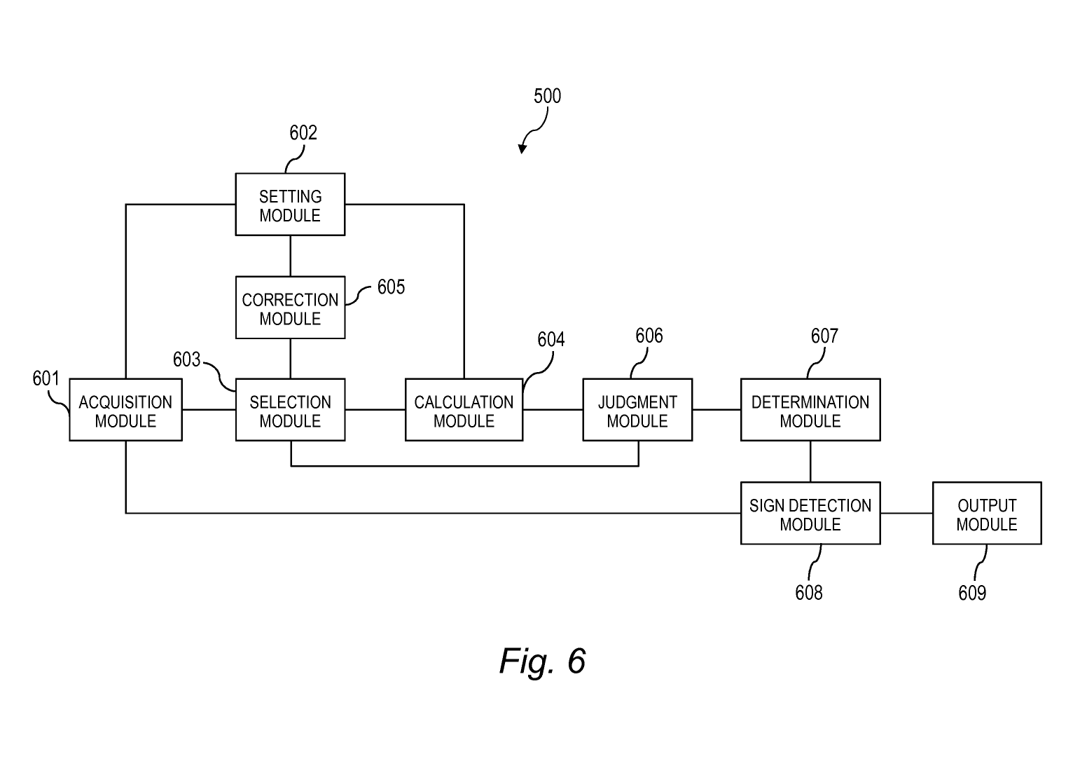

FIG. 6 is a block diagram illustrating a functional configuration example of the detection apparatus 500. The detection apparatus 500 includes an acquisition module 601, a setting module 602, a selection module 603, a calculation module 604, a correction module 605, a judgment module 606, a determination module 607, a sign detection module 608, and an output module 609. The modules 601 to 609 implement their functions specifically by executing with the processor 501 programs that are stored in the storage device 502 of FIG. 5, for example. It should be noted that the sign detection module 608 may be included in an external apparatus capable of communicating to and from the detection apparatus 500 through the communication IF 505.

The acquisition module 601 acquires a plurality of time-series data on a detection target. The detection target is a computer from which a sign of a failure that may occur is to be detected. The number of time-series data to be acquired is two or more to enable the detection of the correlation. When a sign is desired to be detected in system performance of the computer as the detection target, for example, the time-series data such as a CPU utilization rate, latency, and a memory utilization rate are acquired.

Further, when the detection target is a computer for monitoring a traffic situation, for example, the acquisition module 601 acquires a combination of time-series data on vehicle positional information acquired from the global positioning system (GPS) and time-series data on traffic jam information. Further, when the detection target is a computer for executing algorithmic trading, for example, the acquisition module 601 acquires time-series data on a price of a stock and time-series data on a stock price index. Further, when the detection target is a computer for executing stock management and an order placement process, for example, the acquisition module 601 acquires time-series data on a stock quantity of each product and time-series data on a quantity of orders placed. Further, when the detection target is a computer for monitoring a service level, for example, the acquisition module 601 acquires time-series data on service response time and time-series data on system performance and a load. As seen above, there is a variety of combinations of time-series data for which a correlation is to be detected, and hence the detection apparatus 500 is high in its versatility.

The acquired plurality of time-series data are supplied through two routes. One of the routes is a first route, through which the time-series data is supplied to the selection module 603 and the setting module 602 to detect the correlation. The other of the routes is a second route, through which the time-series data is supplied to the sign detection module 608 to execute the sign detection process. In other words, in the first route, the process illustrated in FIG. 1 to FIG. 4 is executed, and it is determined which of the combinations of time-series data is to be assigned to which of the sign detection processes. After that, when the time-series data is acquired, in accordance with such assignment as illustrated in FIG. 4, the acquired time-series data is assigned to the sign detection process as its assignment destination. In this manner, efficient sign detection processing is executed.

The setting module 602 sets, based on a first time period in which the plurality of time-series data acquired by the acquisition module 601 exist, a plurality of second time periods as the inspection ranges. The first time period is the maximum time period that can be set as a time period in which the correlation coefficient is to be detected. For example, in the example of part (b) of FIG. 1, the first time period corresponds to the time period T3. The second time periods are time periods cut out from the first time period. For example, in the example of part (b) of FIG. 1, the second time periods correspond to the time periods T1, T2, and T3. The time period T3 itself may be set as the second time period.

The setting module 602 may set, as the second time period, a time period obtained by being enlarged in a stepwise manner from time or a time period as a basis, or a time period obtained by being reduced in a stepwise manner from the first time period. In part (b) of FIG. 1, when time at the left edge of the dotted-line boundary is set as a basis, the setting module 602 cuts out the time periods T1, T2, and T3 in a stepwise manner. Alternatively, the setting module 602 may set the time period T3 as a basis to cut out the time periods T2 and T1 by reducing the time period T3 in a stepwise manner. In this manner, automatically setting the plurality of second time periods allows the setting module 602 to detect the correlation in each of the second time periods.

The selection module 603 selects, from among the plurality of pieces of time-series data, a combination of two or more time-series data. Specifically, for example, the selection module 603 selects the combinations of time-series data for calculating the correlation coefficient. For example, when time-series data are W, X, Y, and Z, the selection module 603 selects eleven combinations of (W, X), (W, Y), (W, Z), (X, Y), (X, Z), (Y, Z), (W, X, Y), (W, X, Z), (W, Y, Z), (X, Y, Z), and (W, X, Y, Z).

It should be noted that the selection module 603 does not need to select all of those combination, and for example, may designate the number of time-series data to be combined with one another and select the combination of time-series data based on the designated number. For example, when the number of time-series data to be combined with one another is designated to be “3”, the combinations of (W, X, Y), (W, X, Z), (W, Y, Z), and (X, Y, Z) are selected. Further, when the number of time-series data to be combined with one another is designated to be “3 or more”, the combinations of (W, X, Y), (W, X, Z), (W, Y, Z), (X, Y, Z), and (W, X, Y, Z) are selected.

The calculation module 604 calculates, for the combination of two or more time-series data selected by the selection module 603, the correlation coefficient in each of the plurality of second time periods set by the setting module 602. Specifically, for example, in the example of part (b) of FIG. 1, the calculation module 604 calculates, for the data A and B, the correlation coefficient in each of the time periods T1, T2, and T3. It should be noted that the calculation module 604 calculates the correlation coefficient based on such an existing expression for calculating a correlation coefficient R as shown in Expression (1). It should be noted that x, and y, are i-th observed values of given time-series data X and Y, respectively.

$$R = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2}} \sqrt{{\sum }_{i = 1}^{n} {( {y}_{i} - \overline{y} )}^{2}}} \qquad ( 1 )$$

Further, the second time periods are set by being enlarged or reduced by the setting module 602. In other words, the time-series data before enlargement and the time-series data after enlargement partially share the same time-series data, and the time-series data before reduction and the time-series data after reduction partially share the same time-series data. Therefore, when calculating the correlation coefficient before enlargement or reduction, the calculation module 604 holds a sum of the time-series data as an intermediate value, and after the enlargement or reduction, uses the held intermediate value to calculate the correlation coefficient.

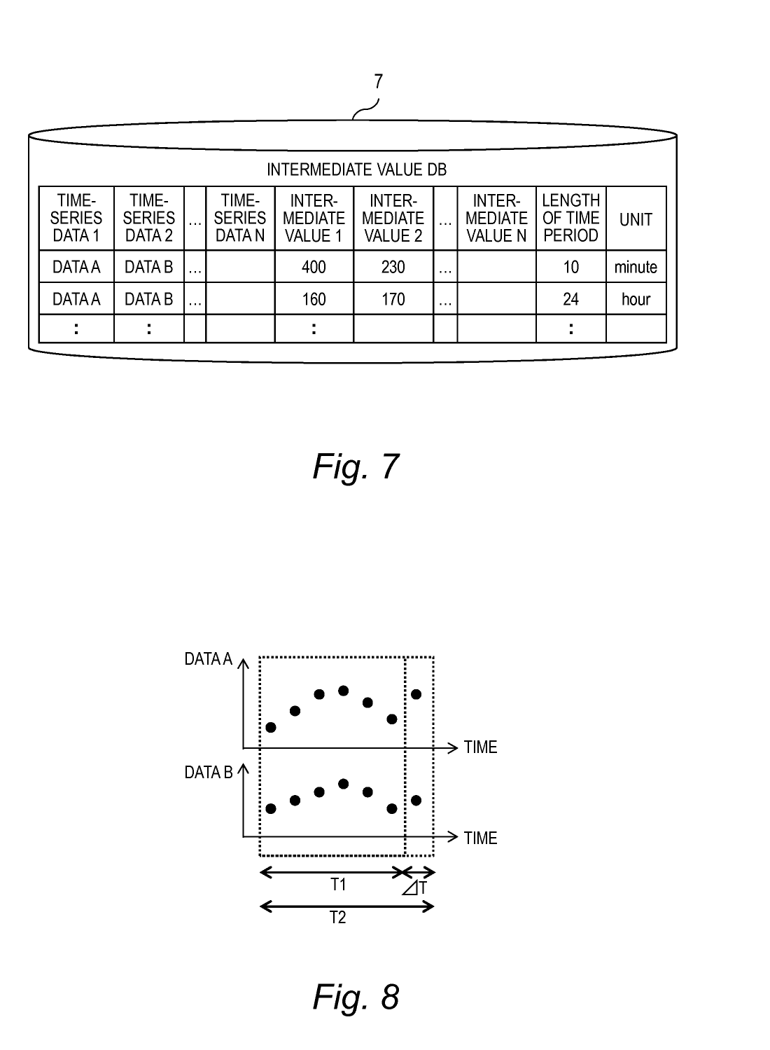

FIG. 7 is an explanatory diagram for showing an example of contents stored in an intermediate value DB 7, and FIG. 8 is an explanatory diagram for showing an example of generation of the intermediate value. FIG. 7 is an example of calculation of the correlation coefficient between the time-series data A and B. For example, if the time period T1 is the second time period that has not been enlarged yet, when the correlation coefficient between the time-series data A and B in the time period T1 is calculated, a sum of a group of observed values forming the time-series data A within the time period T1 and a sum of a group of observed values forming the time-series data B within the time period T1 are acquired. The calculation module 604 stores those sums as the intermediate values in the intermediate value DB 7 of the storage device 502.

Next, if the time period T1 is enlarged by a minute time period ΔT to be the time period T2, when calculating the correlation coefficient between the time-series data A and B in the time period T2, the calculation module 604 reads out the intermediate value held in the intermediate value DB 7, and adds an observed value corresponding to the minute time period ΔT to the intermediate value.

Similarly, if the time period T2 is the second time period that has not been reduced yet, when the correlation coefficient between the time-series data A and B in the time period T2 is calculated, a sum of a group of observed values forming the time-series data A within the time period T2 and a sum of a group of observed values forming the time-series data B within the time period T2 are acquired. The calculation module 604 stores those sums as the intermediate values in the intermediate value DB 7.

Next, if the time period T2 is reduced by the minute time period ΔT to be the time period T1, when calculating the correlation coefficient between the time-series data A and B in the time period T1, the calculation module 604 reads out the intermediate value held in the intermediate value DB 7, and subtracts the observed value corresponding to the minute time period ΔT from the intermediate value. In this manner, executing difference calculation, the calculation module 604 achieves an increase in speed of a calculation process.

Referring back to FIG. 6, the correction module 605 executes a correction process on the time-series data. The correction process includes two types of processes. One of the two types is a smoothing process of smoothing the time-series data, and the other of the two types is a time correction process of shifting the second time period of the time-series data. First, a description is given of the smoothing process. In the smoothing process, the correction module 605 executes a summarization process. The summarization process is a process of dividing the second time period into a plurality of sections (e.g., 1 hour) and calculating, for each of the sections, a mean value of observed values within the section. It should be noted that a value to be used in the summarization process is not limited to the mean value, and a median value may be used, or an arbitrary observed value within the section may be used.

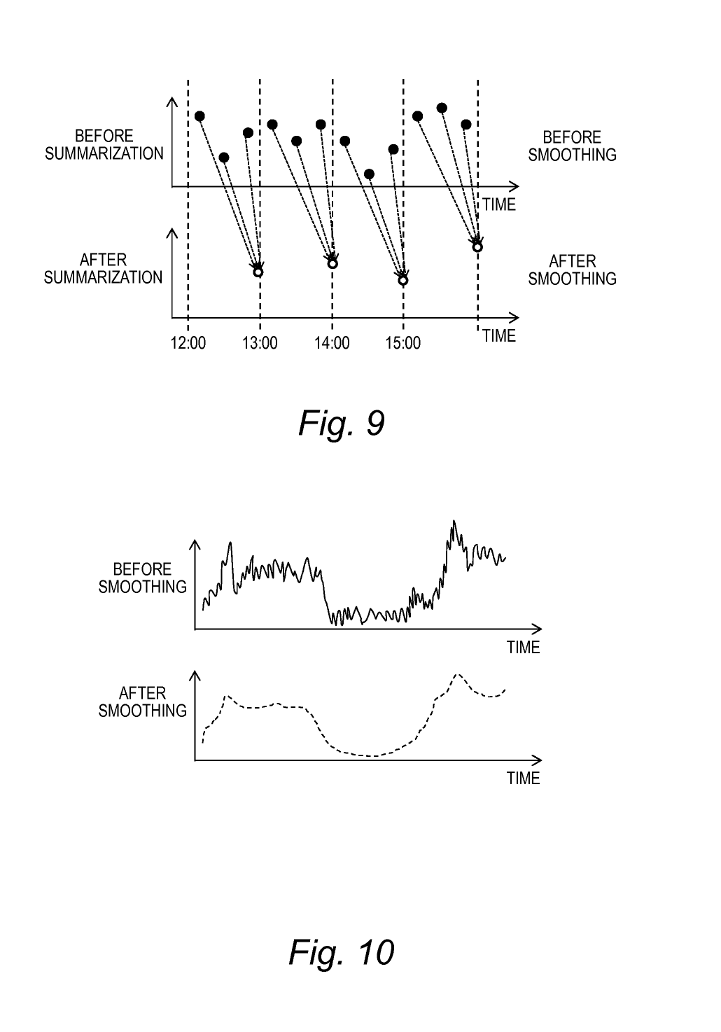

FIG. 9 is an explanatory diagram for showing an example of the summarization process. Although the example in which the second time period is divided into sections in units of a predetermined time period is shown in FIG. 9, the second time period may be divided in units of a predetermined number of observed values. Further, in the smoothing process, the calculation module 604 executes a moving average process. As the moving average process, for example, an existing moving average calculation process such as calculation of a simple moving average or calculation of a weighted moving average is applied.

FIG. 10 is an explanatory diagram for showing the time-series data before and after the smoothing by the moving average process. It should be noted that both of the summarization process and the moving average process may be applied, or any one thereof may be applied. When both of the summarization process and the moving average process are applied, the correction module 605 only needs to execute the summarization process first, and then apply a process result of the summarization process to the moving average process. In this manner, the number of observed values can be reduced by smoothing the time-series data, and the correction module 605 achieves a decrease in load of calculating the correlation coefficient.

Next, a description is given of the time correction process. In the above-mentioned example, the correlation coefficient is calculated in the same second time period for the plurality of combined time-series data. However, depending on the combination of time-series data, due to a group of observed values of one of the time-series data in a given time period, a certain type of sign may be observed in some cases in another of the time-series data after the given period elapses.

When there is a time difference in the combination of the time-series data as in this case, a more realistic correlation coefficient can be acquired when the correlation coefficient is calculated in different time periods than when the correlation coefficient is calculated in the same time period. Therefore, the correction module 605 executes the time correction process to make a setting of eliminating the time difference in the combination of the time-series data.

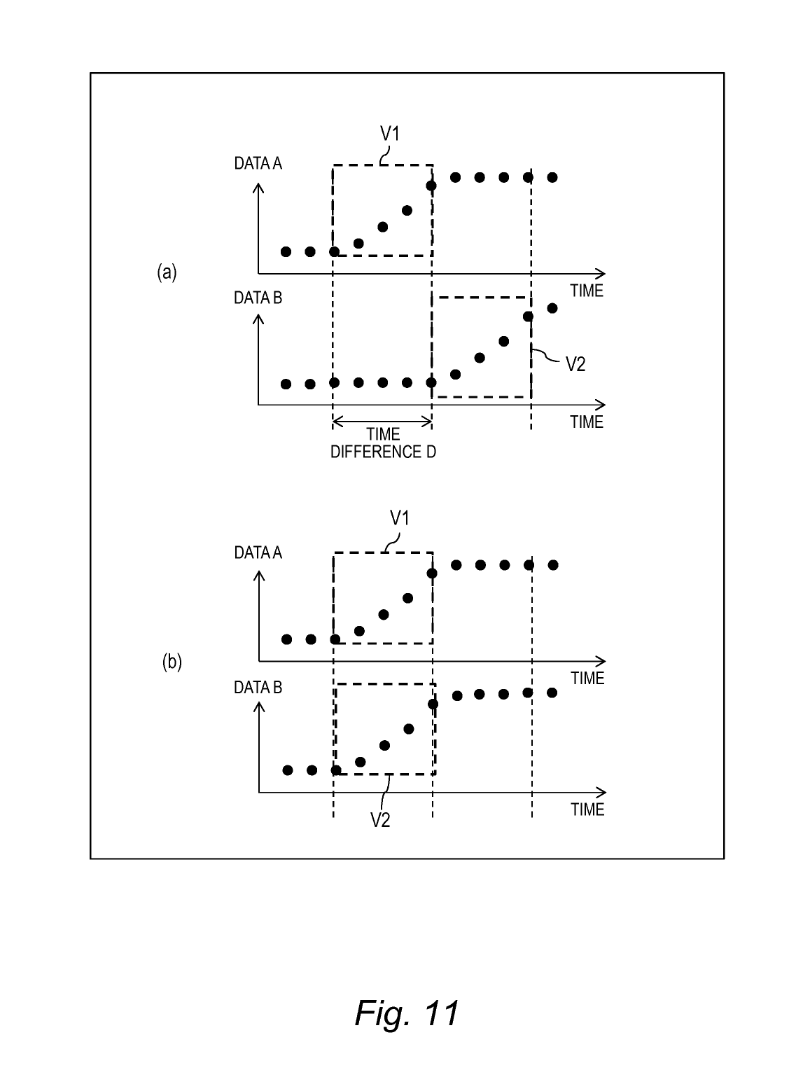

FIG. 11 is an explanatory diagram for showing an example of the time correction process. In part (a) of FIG. 11, the time-series data A and B before time correction are shown. In part (b) of FIG. 11, the time-series data A and B after time correction are shown. When the correlation coefficient is desired to be calculated in the same time period between an observed value group V1 of the time-series data A and an observed value group V2 of the time-series data B, the time difference is eliminated by shifting the time-series data B from a state of part (a) of FIG. 11 by a predetermined time period of D minutes. Therefore, after the time correction, by calculating the correlation coefficient between the time-series data A and B in the same time period, the calculation module 604 can calculate the correlation coefficient from which the time difference is eliminated. It should be noted that the time correction process is optional, and whether or not to execute the time correction process can be selected when necessary through the user's manual input.

Referring back to FIG. 6, the judgment module 606 judges whether or not there is a correlation in the combination of two or more time-series data in each of the plurality of second time periods based on the correlation coefficient calculated by the calculation module 604. For example, the judgment module 606 uses a correlation judgment criterion for the correlation coefficient to judge whether or not there is a correlation. The correlation judgment criterion is a threshold for classification between a case where there is a correlation and a case where there is no correlation. The threshold is set to, for example, 0.7. In this case, when the correlation coefficient is 0.7 or more, it is judged that there is a correlation (positive correlation), when the correlation coefficient is less than −0.7, it is judged that there is a correlation (negative correlation), and when the correlation coefficient is −0.7 or more and less than 0.7, it is judged that there is no correlation.

The judgment module 606 stores the combination of time-series data judged to have a correlation in the correlation information DB 2 as illustrated in FIG. 2. Further, the judgment module 606 stores the combination of time-series data judged to be have no correlation in the non-correlation information DB 3 as illustrated in FIG. 3.

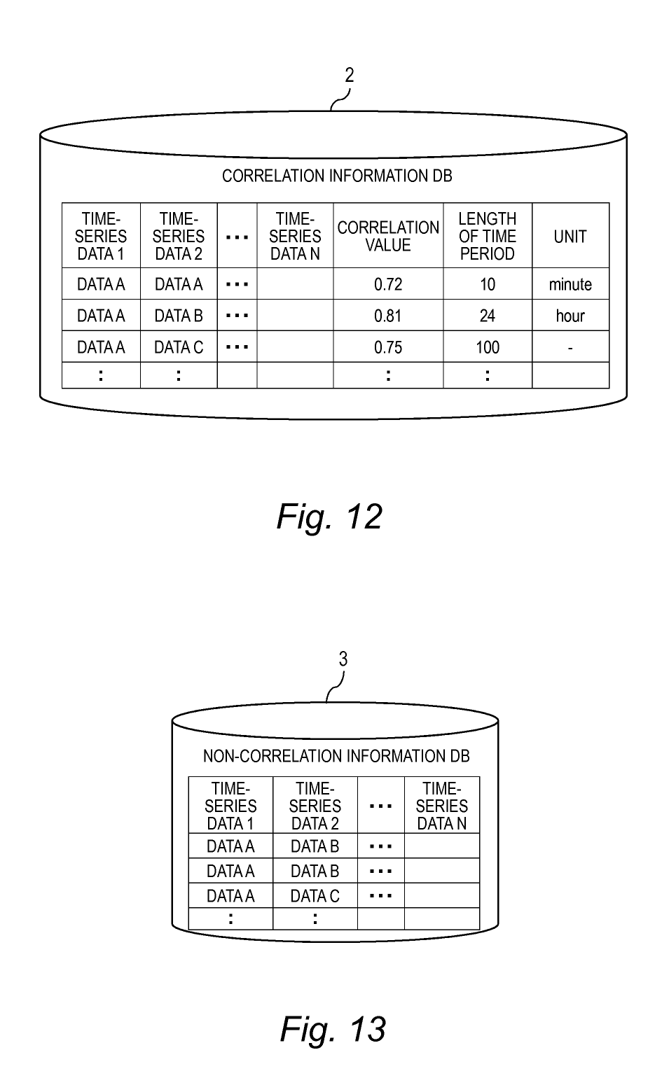

FIG. 12 is an explanatory diagram for showing an example of contents stored in the correlation information DB 2, and FIG. 13 is an explanatory diagram for showing an example of contents stored in the non-correlation information DB 3.

Referring back to FIG. 6, when the judgment module 606 judges that the combination of two or more time-series data has a correlation, the determination module 607 determines, as the assignment destination of the combination of two or more time-series data after the elapse of the first time period, any one of the sign detection processes of detecting a sign of a failure that may occur in the detection target. Specifically, for example, the determination module 607 determines the assignment destination of the combination of time-series data as illustrated in FIG. 4.

Further, when the judgment module 606 judges that there is a correlation in another combination of two or more time-series data including common time-series data that is shared with the combination of two or more time-series data judged to have a correlation, the determination module 607 determines the same sign detection process as the assignment destination after the elapse of the first time period.

Specifically, for example, when there is common time-series data, the determination module 607 determines the same sign detection process as the assignment destination. For example, as illustrated in FIG. 4, the time-series data A and B and the time-series data A and C are each correlated and includes the time-series data A in common, and hence the assignment destinations of both of the combinations are determined to be the same sign detection process. When there is no common time-series data, the assignment destinations of the respective combinations are determined to be different sign detection processes.

Further, when the judgment module 606 judges that there is no correlation in any of the plurality of second time periods in another combination of two or more time-series data including common time-series data that is shared with the combination of two or more time-series data judged to have a correlation, the determination module 607 does not determine the same sign detection process as the assignment destination after the elapse of the first time period.

Specifically, for example, as illustrated in FIG. 3 and FIG. 4, the time-series data A and D are uncorrelated. Therefore, the determination module 607 refers to the non-correlation information DB 3, and does not determine, as the assignment destination of a combination of time-series data including the time-series data D (D, E), the sign detection process corresponding to the assignment destination of the time-series data A.

The sign detection module 608 executes the sign detection process. Specifically, for example, the sign detection module 608 generates the sign detection process, and executes sign detection for each generated sign detection process. The sign detection process involves generating a regression line based on the assigned combination of time-series data.

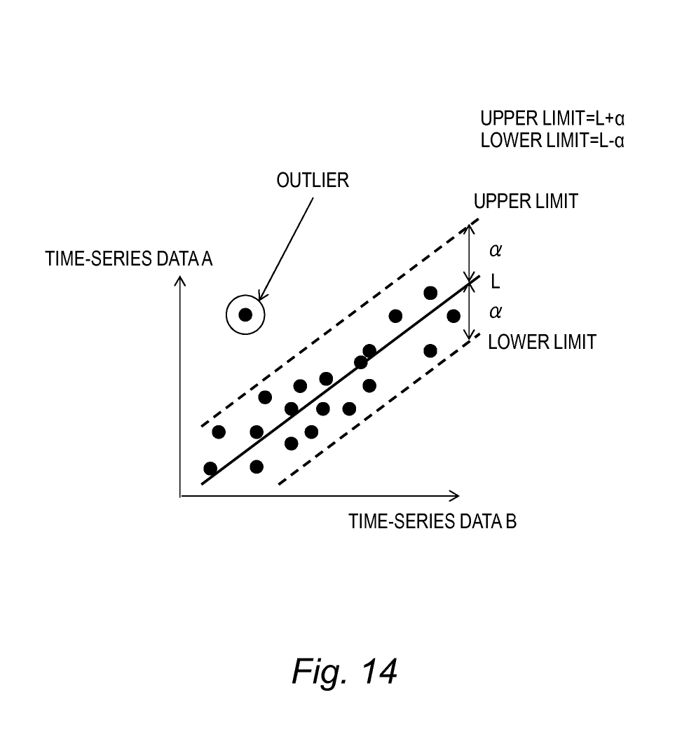

FIG. 14 is an explanatory diagram for showing an example of the regression line. In the example of FIG. 14, a regression line L is defined based on the time-series data A and B. In FIG. 14, a represents a threshold for defining an allowable range of the regression line L. An outlier is an observed value that is outside a range of a standard deviation from the regression line. To each sign detection process, the combination of time-series data processed by the determination module 607 is designated. Now, a description is given of determination of the assignment destination and assignment of the combination of time-series data to the sign detection module 608, which are to be executed by the determination module 607.

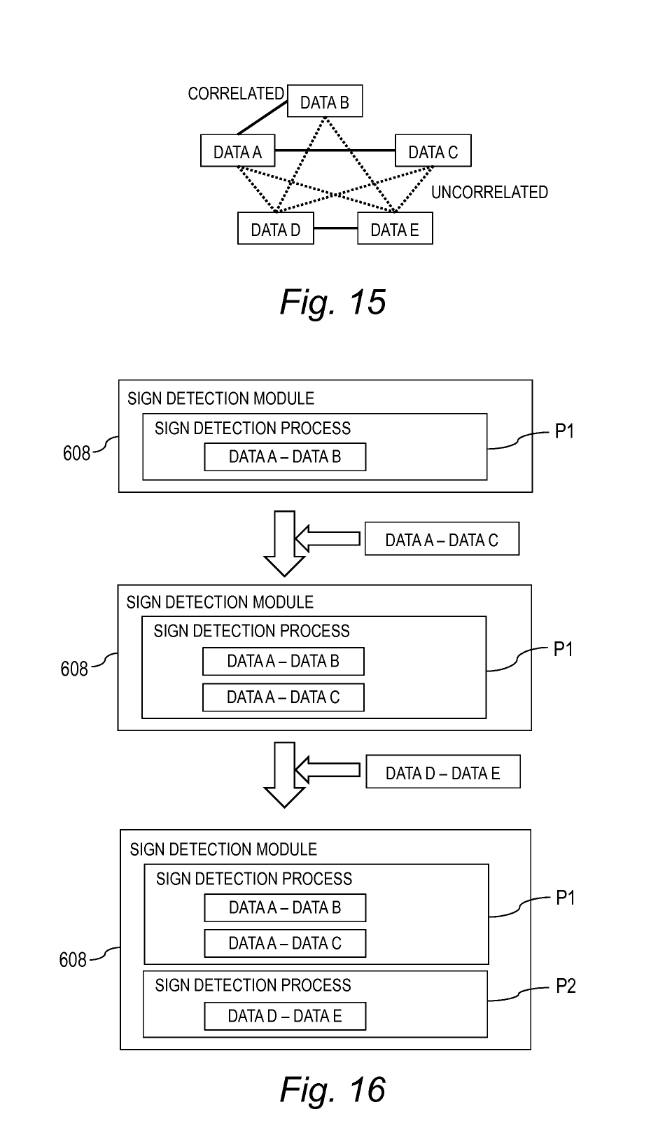

FIG. 15 is an undirected graph for showing an example of whether or not the time-series data are correlated. In the example of FIG. 15, the solid-line link indicates that there is a correlation, and the dotted-line link indicates that there is no correlation. Therefore, the links in the example of FIG. 15 indicate that the time-series data A and B are correlated, the time-series data A and C are correlated, and the time-series data D and E are correlated. It should be noted that it is assumed that in FIG. 15, the judgment module 606 judges that the time-series data A and B are correlated, that the time-series data A and C are correlated, and that the time-series data D and E are correlated, in the stated order.

FIG. 16 is an explanatory diagram for illustrating an example of assignment of the combination of correlated time-series data shown in FIG. 15 to the sign detection process. In FIG. 16, the determination module 607 determines, in accordance with the assignment order described with reference to FIG. 15, the sign detection process as the assignment destination. For example, the determination module 607 first determines a sign detection process P1 as the assignment destination of the time-series data A and B. Next, the time-series data A and B and the time-series data A and C have the time-series data A in common, and hence the determination module 607 determines the sign detection process P1 as the assignment destination of the time-series data A and C. Then, when determining the assignment destination of the time-series data D and E, the determination module 607 does not assign the time-series data A and the time-series data D to the same sign detection process because the time-series data A and D are uncorrelated. In other words, the determination module 607 determines, as the assignment destination of the time-series data D and E, the sign detection process P2 instead of the sign detection process P1.

Referring back to FIG. 6, the output module 609 outputs an execution result of the sign detection process. Examples of the output of the execution result include displaying the execution result on the display as an example of the output device 504, printing out the execution result by the printer, and transmitting the execution result to the communication IF 505 by the external apparatus. Storing the execution result in the storage device 502 also corresponds to the output of the execution result.

<Screen Examples>

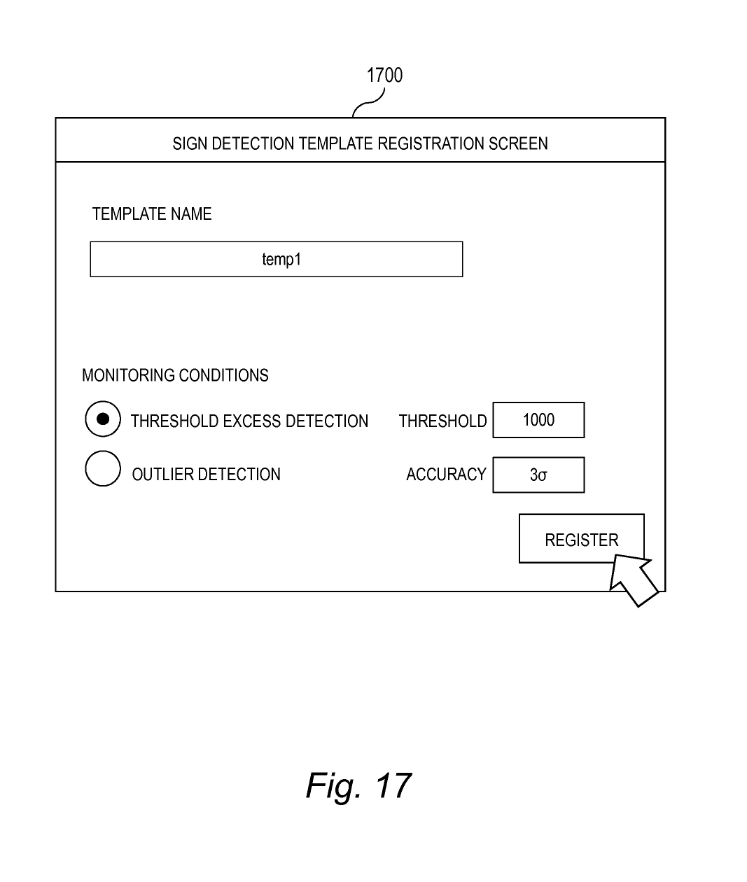

Next, a description is given of screen examples to be output from the detection apparatus 500 with reference to FIG. 17 to FIG. 23.

FIG. 17 is an explanatory diagram for illustrating an example of a sign detection template registration screen. A sign detection template registration screen 1700 is a screen for registering a sign detection template. The sign detection template is model data in which information to be applied to the sign detection process is set. The information to be applied to the sign detection process includes a template name and monitoring conditions. The template name is identification information for uniquely identifying the sign detection template. In the example of FIG. 17, the template name is “temp1”.

The monitoring conditions are conditions to be applied to a monitoring target. The monitoring target is time-series data selected from the combination of time-series data for which the correlation is to be detected. The monitoring conditions include threshold excess detection and outlier detection. The threshold excess detection is a condition for detecting whether or not the observed value of the time-series data as the monitoring target has exceeded the threshold. The threshold is an upper limit and a lower limit from the regression line L using the correlation coefficient calculated from the combination of time-series data. The threshold corresponds to “α” of FIG. 14. As the threshold, an absolute value for defining the upper limit and the lower limit from the regression line L is input. In the example of FIG. 17, “1,000” is input.

The outlier detection is a condition for detecting whether or not the observed value of the time-series data as the monitoring target corresponds to an outlier. The outlier is, as shown in FIG. 14, a value that is outside of a standard error or a confidence interval of the regression line L as a basis. In the outlier detection, a value different from a normal tendency is regarded as a sign of a failure. As accuracy, a value defining the standard deviation or the confidence interval is input. In the example of FIG. 17, “3σ”, which is a triple of the standard deviation, is input. It should be noted that when a “Register” button is depressed, the sign detection template is registered and stored in the storage device.

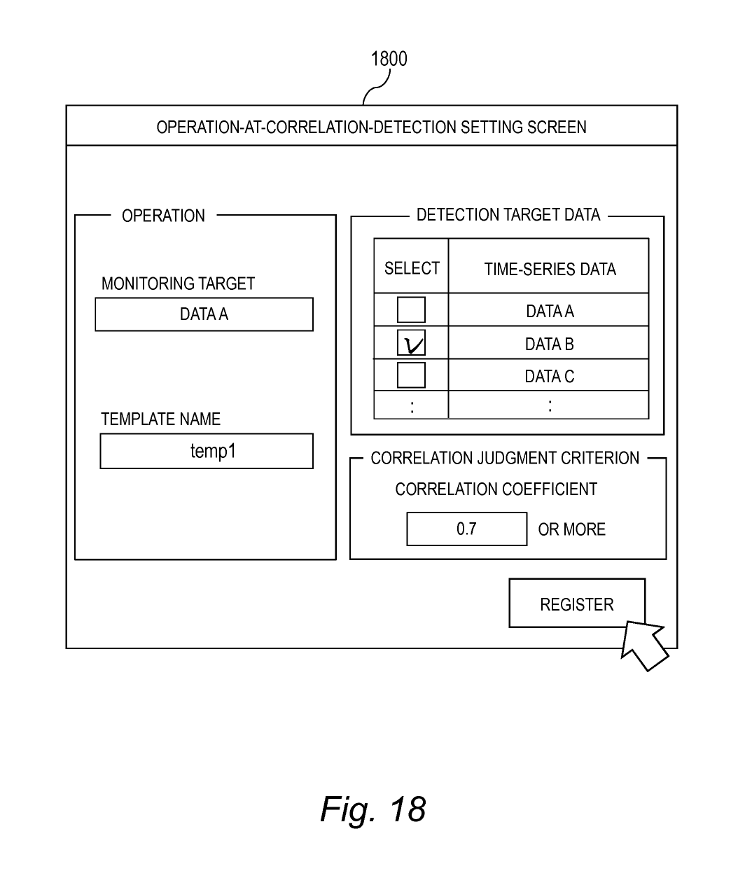

FIG. 18 is an explanatory diagram for illustrating an example of an operation-at-correlation-detection setting screen. The operation-at-correlation-detection setting screen 1800 is a screen for setting an operation to be executed at the time of correlation detection. Information to be set includes an operation, a detection target, and a correlation judgment criterion. The operation is information for defining a detection operation to be executed by the detection apparatus 500. The operation includes a monitoring target and a template name. The monitoring target is information for uniquely identifying time-series data selected from a combination of time-series data for which the correlation is to be detected. In the example of FIG. 18, the monitoring target is the “time-series data A”. The template name is identification information for uniquely identifying the sign detection template. A template corresponding to the input template name is applied. The template to be applied is a template registered in the sign detection template registration screen 1700 illustrated in FIG. 17. In the example of FIG. 18, the template name is “temp1”, which is registered in FIG. 17.

The detection target is the time-series data for which the correlation is to be detected. The user operates the input device 503 to check a checkbox corresponding to the time-series data desired to be selected as the detection target. In the case of FIG. 18, the time-series data B is selected. In this manner, the detection apparatus 500 detects a correlation between the time-series data A as the monitoring target and the time-series data B selected as the detection target.

The correlation judgment criterion is an absolute value of the correlation coefficient to be used by the judgment module 606 as a judgment criterion. When the correlation coefficient calculated based on the combination of time-series data is the correlation judgment criterion or more, the judgment module 606 judges that those time-series data are correlated. When the correlation coefficient is less than the correlation judgment criterion, the judgment module 606 judges that those time-series data are uncorrelated. In the example of FIG. 18, the correlation judgment criterion is 0.7, and hence it is judged that there is a correlation when the correlation coefficient is 0.7 or more or when the correlation coefficient is less than −0.7.

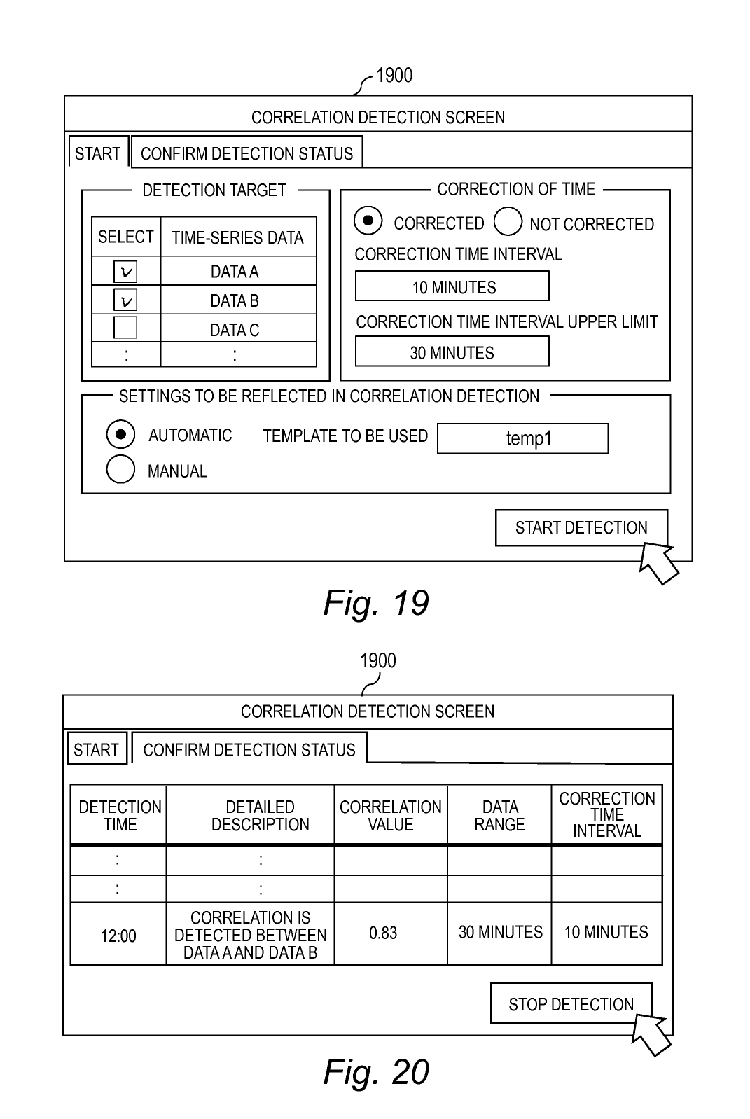

FIG. 19 and FIG. 20 are each an explanatory diagram for illustrating an example of a correlation detection screen. A correlation detection screen 1900 is a screen relating to the process of detecting the correlation. FIG. 19 is a screen example displayed when a “Start” tab is selected, and FIG. 20 is a screen example displayed when a “Confirm Detection Status” tab is selected. The “Start” tab is a setting screen displayed before execution of the detection process. The “Confirm Detection Status” tab is a confirmation screen displayed during the execution of the detection process.

In FIG. 19, the “Start” tab includes a detection target, correction of time, and settings to be reflected in correlation detection. The detection target is the time-series data for which the correlation is to be detected. The user operates the input device 503 to check a checkbox corresponding to the time-series data desired to be selected as the detection target. In the case of FIG. 19, the time-series data A and B are selected.

The correction of time is information for defining time correction to be executed by the correction module 605. When a radio button “Corrected” is selected, such a correction process as shown in FIG. 11 is executed. A correction time interval is a time interval by which the time-series data is to be corrected by the time correction process. In the example of FIG. 19, the correction time interval is 10 minutes, and hence the time-series data is shifted at intervals of 10 minutes. A correction time interval upper limit is an upper limit of the correction time interval. In the example of FIG. 19, the correction time interval upper limit is 30 minutes. Therefore, the time-series data is not shifted by a time interval exceeding 30 minutes. A correction target is information for uniquely identifying time-series data to be subjected to time correction (not expressed with FIG. 19). For example, the correction target is the time-series data B.

The settings to be reflected in correlation detection are information for defining contents to be reflected at the time of correlation detection. When a radio button “Automatic” is selected, the user can operate the input device to designate a template desired to be applied. In the example of FIG. 19, “temp 1” is designated. When a radio button “Manual” is selected, a template cannot be designated, and a correlation in a combination of time-series data selected in the “Detection Target” is detected. In other words, when “Automatic” is selected, a template designated as a “Template to be used” is used to detect the correlation for the combination of time-series data set in FIG. 18. On the other hand, when “Manual” is selected, the correlation is detected for the combination of time-series data selected in the “Detection Target” of FIG. 19. When a “Start Detection” button is depressed, the detection process is started.

In FIG. 20, the “Confirm Detection Status” tab displays a detection status. The detection status is detection time, a detailed description, a correlation value, a data range, and a correction time interval. The detection time is time at which a correlation is detected. In the example of FIG. 20, the detection time is “12:00”. The detailed description is a character string stating a combination of time-series data detected to have a correlation. In the example of FIG. 20, the detailed description is “Correlation Is Detected between Data A and Data B”.

The correlation value is a value of the correlation coefficient calculated for the combination of time-series data stated in the detailed description. In the example of FIG. 20, the correlation value is “0.83”. The data range is a length of a time period in which the correlation coefficient is detected. In the example of FIG. 20, the data range is “30 Minutes”. It should be noted that the time period in which the correlation is detected is identified based on the detection time and the data range. In the example of FIG. 20, a time period of 12:00 to 12:30 is a time period in which the correlation is detected for the combination of the data A and the data B. The correction time interval is a time interval by which the time-series data is corrected by the time correction process. In the example of FIG. 20, the correction time interval is “10 Minutes”. It should be noted that when a “Stop Detection” button is depressed, the detection process is stopped.

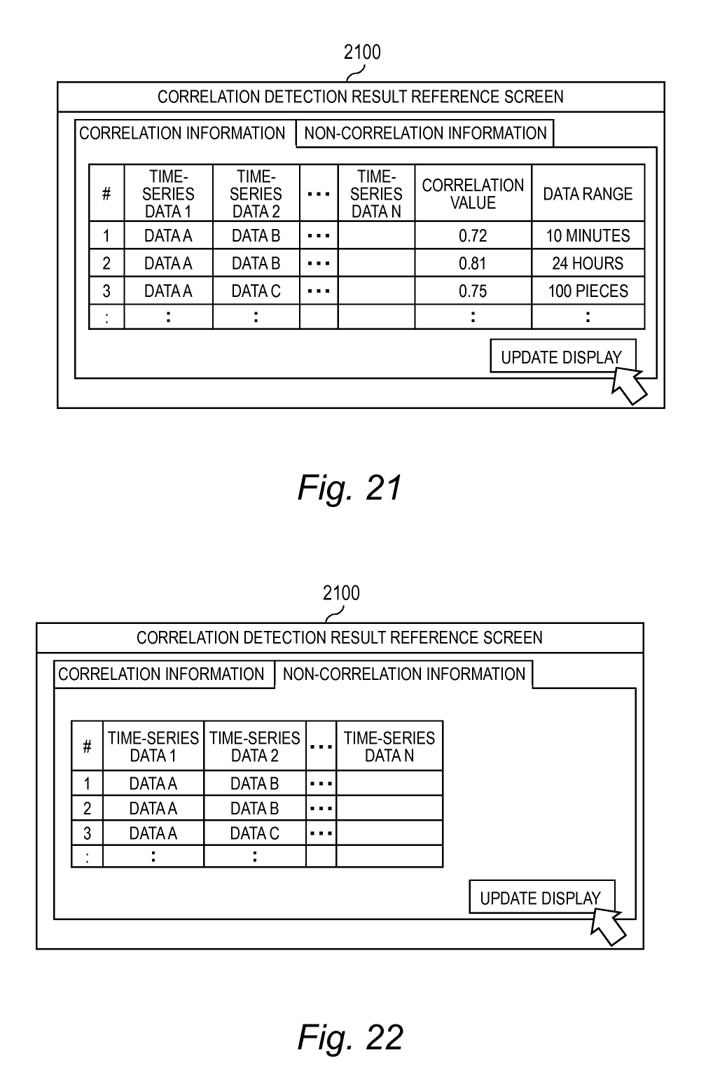

FIG. 21 and FIG. 22 are each an explanatory diagram for illustrating an example of a correlation detection result reference screen. The correlation detection result reference screen 2100 is a screen on which a result of the correlation detection can be referred to. When the process of detecting the correlation is finished, the correlation detection result reference screen 2100 can be invoked. The correlation detection result reference screen 2100 includes a “Correlation Information” tab and a “Non-correlation Information” tab. As illustrated in FIG. 21, the “Correlation Information” tab displays information stored in the correlation information DB 2. As illustrated in FIG. 22, the “Non-correlation Information” tab displays information stored in the non-correlation information DB 3.

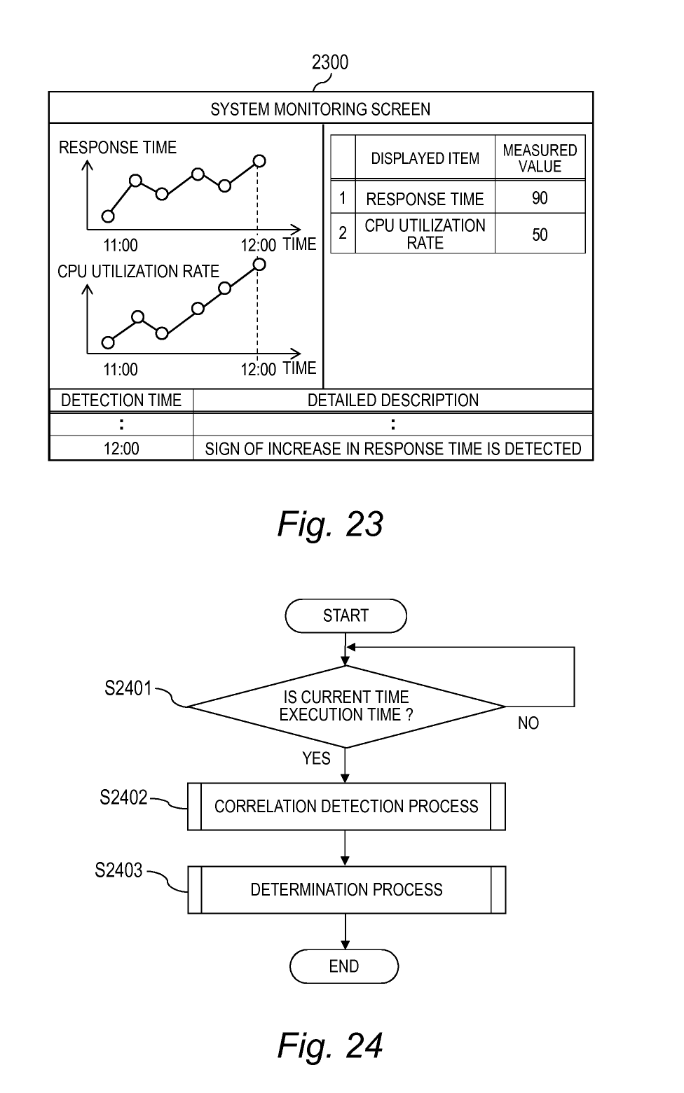

FIG. 23 is an explanatory diagram for illustrating an example of a system monitoring screen. A system monitoring screen 2300 is a screen for displaying details of monitoring of the time-series data from a system as the monitoring target. The system monitoring screen 2300 is also a screen for outputting a detection result from the sign detection module 608.

<Example of Detection Process>

FIG. 24 is a flowchart for illustrating an example of a process procedure of detecting the correlation, which is to be executed by the detection apparatus 500. First, the detection apparatus 500 judges whether or not current time is execution time (Step S2401). The execution time is time at which the process procedure is to be executed in a case of a batch process. Further, in a case of a manual operation, the execution time is, for example, time at which the “Start Detection” button illustrated in FIG. 19 is depressed.

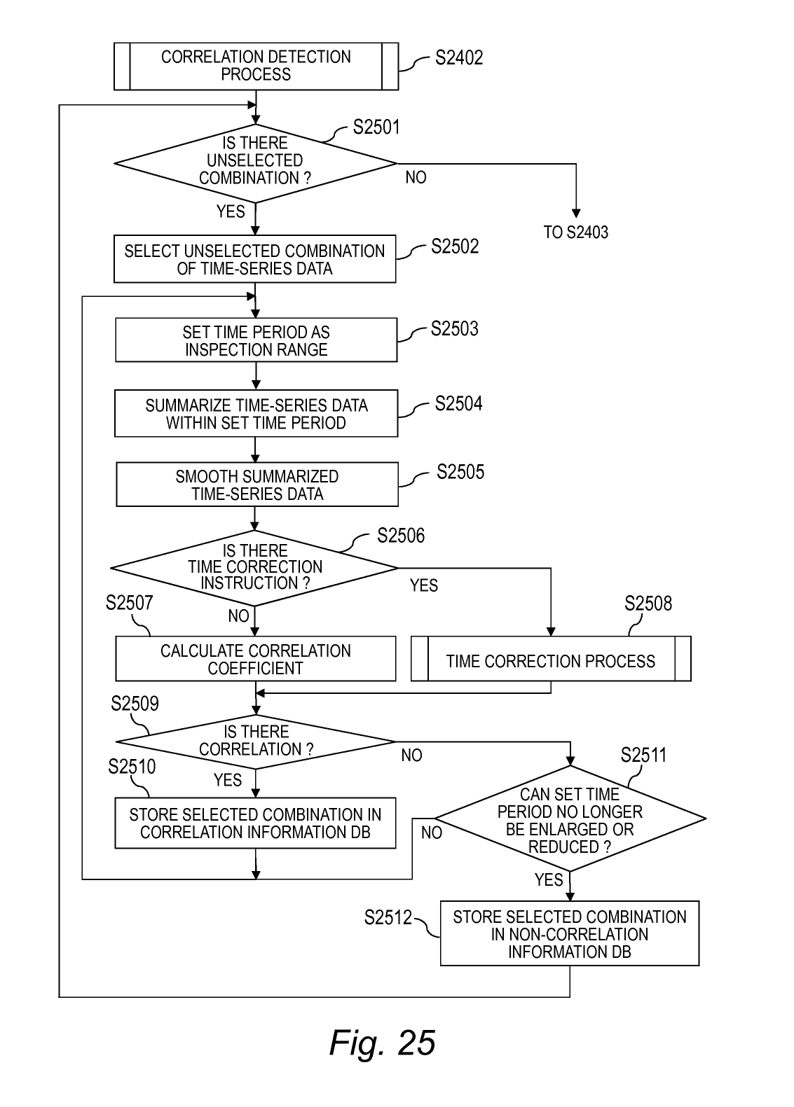

When the current time is not the execution time (Step S2401: No), the detection apparatus 500 waits until the execution time is reached (Step S2401). When the current time is the execution time (Step S2401: Yes), the detection apparatus 500 executes a correlation detection process (Step S2402). In the correlation detection process (Step S2402), the detection apparatus 500 detects a correlation in a combination of time-series data as illustrated in part (b) of FIG. 1, FIG. 2, and FIG. 3. A detailed process procedure example of the correlation detection process (Step S2402) is described later with reference to FIG. 25.

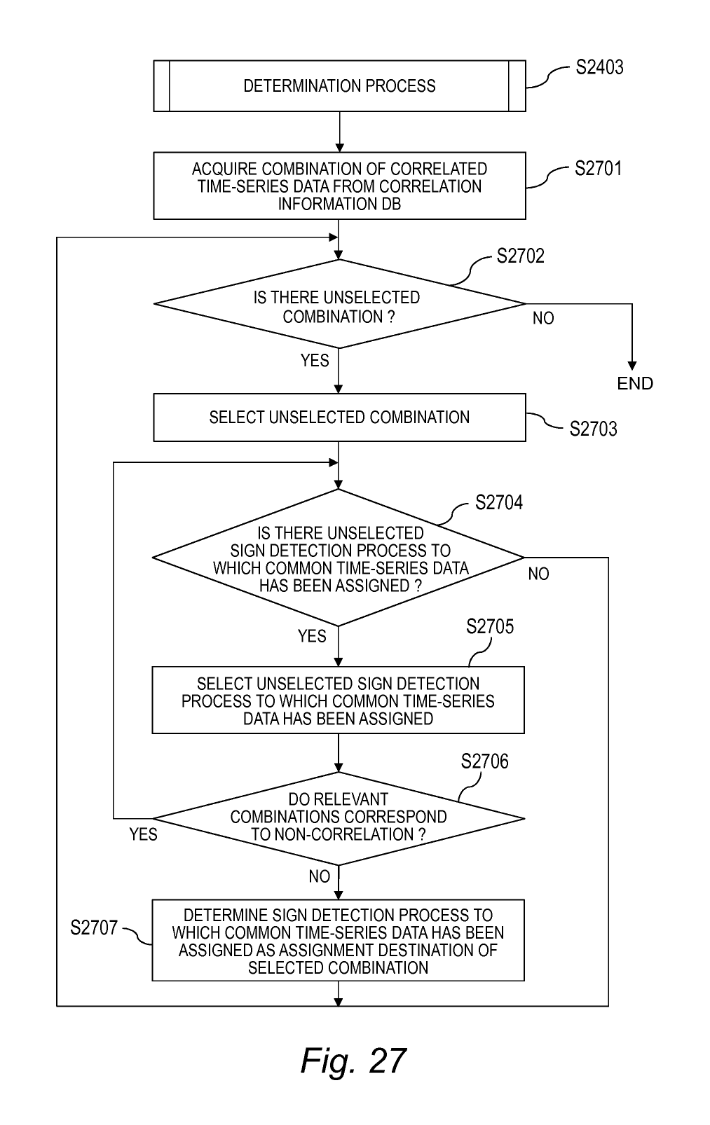

Next, the detection apparatus 500 executes a determination process (Step S2403). In the determination process (Step S2403), the detection apparatus 500 determines the sign detection process as the assignment destination of the combination of correlated time-series data. A detailed process procedure example of the determination process (Step S2403) is described later with reference to FIG. 27.

FIG. 25 is a flowchart for illustrating the detailed process procedure example of the correlation detection process (Step S2402) illustrated in FIG. 24. It should be noted that the correlation detection process (Step S2402) is executed in accordance with the contents set in FIG. 17 and FIG. 18 described above.

First, the detection apparatus 500 judges whether or not there is an unselected combination of time-series data (Step S2501). When there is an unselected combination of time-series data (Step S2501: Yes), the detection apparatus 500 uses the selection module 603 to select the unselected combination of time-series data (Step S2502), and uses the setting module 602 to set a time period as the inspection range (Step S2503).

Then, the detection apparatus 500 uses the correction module 605 to summarize the time-series data within the set time period as shown in FIG. 9 (Step S2504) and smooth the summarized time-series data as shown in FIG. 10 (Step S2505). After that, the detection apparatus 500 judges whether or not there is a time correction instruction (Step S2506). For example, in the correlation detection screen 1900 of FIG. 19, when the radio button “Corrected” is selected, it is judged that there is a time correction instruction (Step S2506: Yes).

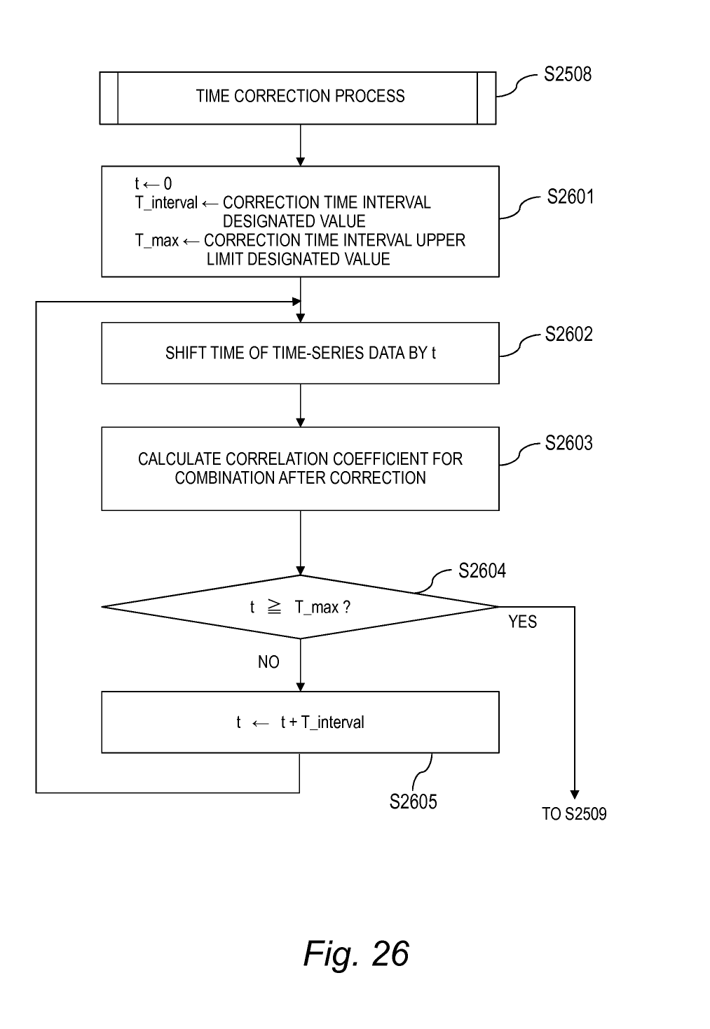

When there is no time correction instruction (Step S2506: No), the detection apparatus 500 uses the calculation module 604 to calculate the correlation coefficient for the selected combination of time-series data (Step S2507), and the process procedure proceeds to Step S2509. On the other hand, when there is a time correction instruction (Step S2506: Yes), the detection apparatus 500 uses the calculation module 604 and the correction module 605 to execute the time correction process (Step S2508), and the process procedure proceeds to Step S2507. The time correction process (Step S2508) is a process of correcting time of the time-series data as shown in FIG. 11. A detailed process procedure example of the time correction process (Step S2508) is described later with reference to FIG. 26.

Then, in Step S2509, the detection apparatus 500 uses the judgment module 606 to judge whether or not there is a correlation in the selected combination of time-series data (Step S2509). When there is a correlation (Step S2509: Yes), the detection apparatus 500 stores the selected combination of time-series data in the correlation information DB 2 (Step S2510), and the process procedure proceeds to Step S2503. After that, the set time period is enlarged or reduced as shown in FIG. 8.

On the other hand, when there is no correlation (Step S2509: No), the detection apparatus 500 judges whether or not the set time period can no longer be enlarged or reduced (Step S2511). For example, when the set time period exceeds the first time period after being reset by the setting module 602, the set time period can no longer be enlarged. Further, when the set time period disappears after being reset by the setting module 602, the set time period can no longer be reduced. When the set time period can be enlarged or reduced (Step S2511: No), the process procedure proceeds to Step S2503. After that, the set time period is enlarged or reduced as shown in FIG. 8.

On the other hand, when the set time period can no longer be enlarged or reduced (Step S2511: Yes), the detection apparatus 500 stores the selected combination of time-series data in the non-correlation information DB 3 (Step S2512), and the process procedure returns to Step S2501. In Step S2501, when there is no unselected combination of time-series data (Step S2501: No), the process procedure proceeds to the determination process (Step S2403).

FIG. 26 is a flowchart for illustrating the detailed process procedure example of the time correction process (Step S2508) illustrated in FIG. 25. First, the detection apparatus 500 sets an initial value of a time interval t by which the time-series data is to be shifted to t=0, sets T_interval to the correction time interval that is input to the correlation detection screen 1900 of FIG. 19, and sets T_max to the correction time interval upper limit that is input to the correlation detection screen 1900 as well (Step S2601).

Next, the detection apparatus 500 shifts time of the time-series data as the correction target by t minutes (Step S2602). Then, the detection apparatus 500 calculates the correlation coefficient for the combination of time-series data after the correction (Step S2603). Then, the detection apparatus 500 judges whether or not t is T_max or more (Step S2604). When t is less than T_max (Step S2604: No), the detection apparatus 500 adds t to T_interval (Step S2605), and the process procedure returns to Step S2602. On the other hand, when t is T_max or more (Step S2604: Yes), the detection apparatus 500 finishes the time correction process (Step S2508), and the process procedure proceeds to Step S2509. In this manner, each time the time correction is executed, the correlation coefficient for the combination of time-series data after the correction is calculated, and hence it is possible to finely judge in which period there is a correlation.

FIG. 27 is a flowchart for illustrating a detailed process procedure example of the determination process (Step S2403) illustrated in FIG. 25. First, the detection apparatus 500 acquires the combination of correlated time-series data from the correlation information DB 2 (Step S2701). Then, the detection apparatus 500 judges whether or not there is an unselected combination of time-series data among the acquired combinations (Step S2702). When there is an unselected combination of time-series data (Step S2702: Yes), the detection apparatus 500 selects the unselected combination of time-series data (Step S2703). Then, the detection apparatus 500 judges whether or not there is an unselected sign detection process to which common time-series data has been assigned (Step S2704).

When there is an unselected sign detection process to which common time-series data has been assigned (Step S2704: Yes), the detection apparatus 500 selects the unselected sign detection process to which common time-series data has been assigned (Step S2705). For example, it is assumed that a combination of time-series data selected in Step S2703 is (A, C). In Step S2705, for example, the detection apparatus 500 selects the sign detection process to which a combination of time-series data (A, B) including the common time-series data A has been assigned.

Then, the detection apparatus 500 refers to the non-correlation information DB 3 to judge whether or not the combination of time-series data selected in Step S2703 and the combination of time-series data that has been assigned to the sign detection process correspond to non-correlation (Step S2706). It is assumed that a combination of uncorrelated time-series data is (A, D). For example, when a combination of time-series data selected in Step S2703 is (D, E), the combination (D, E) includes the time-series data D, which is included in the combination of uncorrelated time-series data (A, D). Therefore, the combination of time-series data (D, E) selected in Step S2703 and the combination of time-series data (A, B) that has been assigned to the sign detection process correspond to the non-correlation.

When the above-mentioned combinations correspond to the non-correlation (Step S2706: Yes), the process procedure returns to Step S2704, and the detection apparatus 500 selects another unselected sign detection process again. On the other hand, when the above-mentioned combinations do not correspond to the non-correlation (Step S2706: No), the detection apparatus 500 determines the sign detection process selected in Step S2705 as the assignment destination of the combination of time-series data selected in Step S2703 (Step S2707). The process procedure then returns to Step S2702. Further, in Step S2704, also when there is no unselected sign detection process to which common time-series data has been assigned (Step S2704: No), the process procedure returns to Step S2702.

In Step S2702, when there is no unselected combination of time-series data (Step S2702: No), the determination process (Step S2403) ends. After that, the process procedure of FIG. 24 ends.

<Sign Detection>

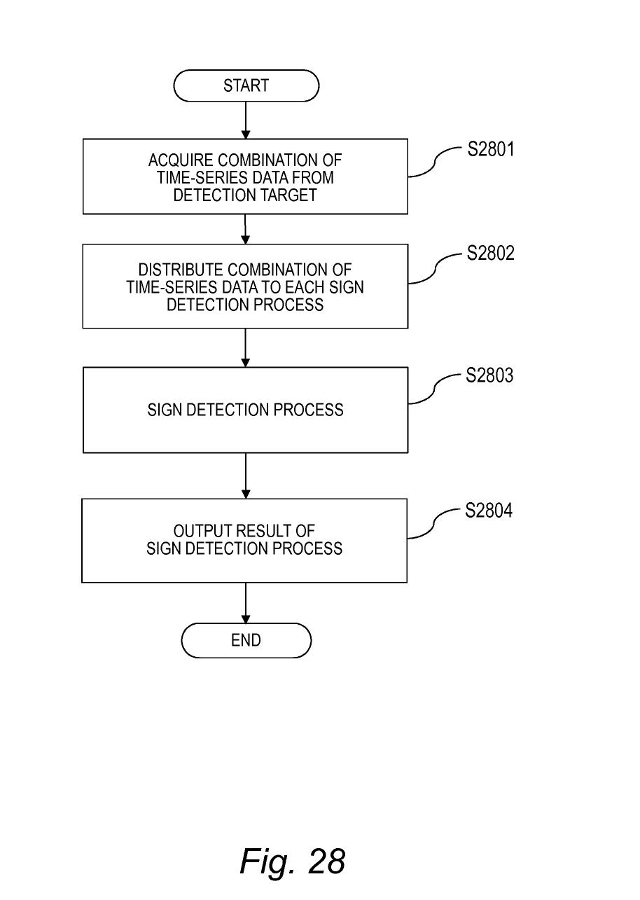

FIG. 28 is a flowchart for illustrating a detailed process procedure example of sign detection, which is to be executed by the detection apparatus 500. First, the detection apparatus 500 uses the acquisition module 601 to acquire a combination of time-series data from the detection target (Step S2801), and distributes the acquired combination of time-series data to each sign detection process (Step S2802). In Step S2802, the combination of time-series data is distributed to the sign detection process determined as its assignment destination by the determination process (Step S2403) illustrated in FIG. 27. Then, the detection apparatus 500 uses the sign detection module 608 to execute each sign detection process (Step S2803).

The sign detection process involves generating, for the combination of time-series data acquired in the past, a regression line L, a threshold a, a standard deviation, and the like as shown in FIG. 14. The sign detection process further involves judging whether the combination of time-series data acquired this time in Step S2801 exists within a range of the threshold a for the regression line L or corresponds to an outlier. The sign detection process still further involves judging that the combination of time-series data acquired this time is a sign of a failure when this combination of time-series data is outside the range of the threshold a or corresponds to the outlier. Then, the detection apparatus 500 outputs a result of the sign detection process as illustrated in FIG. 23 (Step S2804). After that, the sign detection ends.

As described above, according to this embodiment, the correlation coefficient of a combination of time-series data is calculated in each of the plurality of time periods, and hence even when there is no correlation in the combination of time-series data in a given time period, it is possible to confirm that there is a correlation in another time period. Further, even when there is a correlation in a given time period, it is possible to confirm that there is no correlation in another time period. In this manner, by confirming the correlations in the plurality of time periods, it is possible to reduce a probability that a correlation or no correlation is overlooked. It is therefore possible to achieve the enhancement in reliability of the sign detection.

Further, by enlarging or reducing a given time period to set the plurality of time periods, it is possible to simplify setting of the plurality of time periods, and hence it is possible to achieve a more efficient setting process. Further, the plurality of time periods may be set by being enlarged or reduced by a predetermined time period each, or enlarged or reduced by a predetermined data amount each. In this manner, the time period can be enlarged or reduced in terms of both of the length of the time period and the data amount, and it is possible to achieve enhancement in versatility.

Further, by holding the intermediate value that is acquired when the correlation coefficient is calculated for the time period that has not been subjected to enlargement or reduction yet and using the held intermediate value to calculate the correlation coefficient for the time period that has been subjected to the enlargement or reduction, it is possible to achieve an increase in speed of the process of calculating the correlation coefficient. Further, by executing the correction of reducing the number of pieces of data of each of the time-series data included in the combination of time-series data, it is possible to achieve an increase in speed of the process of calculating the correlation coefficient.

Further, by executing the correction of shifting any one of the time-series data included in the combination of time-series data by a predetermined time interval, it is possible to detect a correlation that cannot be detected in the comparison in the same time period. For example, when the combination of time-series data is a resource utilization rate, such as a memory utilization rate or a CPU utilization rate, and service response time, it is possible to detect that there is a correlation in such a combination of time-series data in a case where, for example, the resource utilization rate gradually increases, and the service response time increases after a predetermined time period along with the increase in resource utilization rate.

Specifically, there is a correlation between an increase in resource utilization rate and an increase in service response time, but there is a time difference between the increases in values, and hence the correlation cannot be detected when the correlation is detected in the same time period. Through the creation of this correlation by correcting the time difference between an increase in resource utilization rate and an increase in response time, an increase in resource utilization rate is monitored. In this manner, it is possible to detect a sign of an increase in response time.

Further, when there is common time-series data shared among given combinations among a group of combinations of correlated time-series data, by determining the same sign detection process as the assignment destination of the respective combinations, it is possible to use the common time-series data in the same sign detection process. It is therefore possible to achieve more efficient sign detection processing.

Further, when a group of time-series data having time-series data included in one of combinations of correlated time-series data and another time-series data included in another one of the combinations is a combination having no correlation, by determining different sign detection processes as the assignment destinations of the respective combinations, it is possible to preferentially assign the combination having a correlation to the assignment destination. Specifically, when a combination C of time-series data having time-series data included in one of combinations A and B of correlated time-series data and another time-series data included in another one of the combinations A and B has no correlation, the combinations A and B of time-series data are assigned to different sign detection processes. In this manner, it is possible to limit the combination of time-series data to be assigned to the sign detection process to the combination of correlated time-series data, and hence it is possible to reduce a load of the sign detection process. Further, by executing a plurality of sign detection processes in parallel, it is possible to achieve more efficient sign detection processing.

This invention has been described in detail so far with reference to the accompanying drawings, but this invention is not limited to those specific configurations described above, and includes various changes and equivalent components within the gist of the scope of claims appended.

What is claimed is:

1. A detection apparatus, comprising:
an acquisition module configured to acquire a plurality of time-series data on a detection target;
a setting module configured to set, based on a first time period in which the plurality of time-series data acquired by the acquisition module exist, a plurality of second time periods as inspection ranges;
a selection module configured to select a combination of two or more time-series data from among the plurality of time-series data; and
a calculation module configured to calculate a correlation coefficient in each of the plurality of second time periods set by the setting module for the combination of two or more time-series data selected by the selection module.

2. The detection apparatus according to claim 1,
wherein the setting module executes one of enlarging a third time period within the first time period and reducing the third time period, to thereby set the plurality of second time periods, and
wherein the calculation module calculates the correlation coefficient in the each of the plurality of second time periods set by the setting module for the combination of two or more time-series data selected by the selection module.

3. The detection apparatus according to claim 2, wherein the calculation module holds an intermediate value that is acquired when the correlation coefficient is calculated for each of the plurality of second time periods that have not been subjected to one of enlargement and reduction yet, and uses the held intermediate value to calculate the correlation coefficient for the each of the plurality of second time periods that have been subjected to the one of the enlargement and the reduction.

4. The detection apparatus according to claim 1, further comprising a correction module configured to execute correction of reducing a number of pieces of data of each of the two or more time-series data included in the combination of two or more time-series data within the each of the plurality of second time periods,
wherein the calculation module calculates the correlation coefficient for the combination of two or more time-series data that have been corrected by the correction module.

5. The detection apparatus according to claim 1, further comprising a correction module configured to execute correction of shifting the each of the plurality of second time periods by a predetermined time period for any one of the two or more time-series data included in the combination of two or more time-series data within the each of the plurality of second time periods,
wherein the calculation module calculates the correlation coefficient for the combination of the two or more time-series data that have been corrected by the correction module.

6. The detection apparatus according to claim 1, further comprising:
a judgment module configured to judge whether or not there is a correlation in the combination of two or more time-series data in the each of the plurality of second time periods based on the correlation coefficient calculated by the calculation module;
a determination module configured to determine, when the judgment module judges that there is a correlation in the combination of two or more time-series data, any one of sign detection processes for detecting a sign of a failure that is to occur in the detection target as an assignment destination of the combination of two or more time-series data after elapse of the first time period; and
an output module configured to output an execution result of the one of sign detection processes determined by the determination module as the assignment destination of the combination of two or more time-series data after the elapse of the first time period.

7. The detection apparatus according to claim 6, wherein when the judgment module judges that there is a correlation in another combination of two or more time-series data including common time-series data shared with the combination of two or more time-series data judged to have the correlation, the determination module determines the one of sign detection processes as an assignment destination of the another combination of two or more time-series data after the elapse of the first time period.

8. The detection apparatus according to claim 6, wherein when the judgment module judges that there is no correlation in another combination of two or more time-series data including common time-series data shared with the combination of two or more time-series data judged to have the correlation in any of the plurality of second time periods, the determination module avoids determining the one of sign detection processes as an assignment destination of the another combination of two or more time-series data after the elapse of the first time period.

9. The detection apparatus according to claim 6,
wherein when the judgment module judges that there is a correlation in another combination of two or more time-series data including no common time-series data shared with the combination of two or more time-series data judged to have the correlation, the determination module determines another one of the sign detection processes different from the one of sign detection processes as an assignment destination of the another combination of two or more time-series data after the elapse of the first time period, and
wherein the output module outputs the execution result of the one of sign detection processes and an execution result of the another one of the sign detection processes.

10. The detection apparatus according to claim 9, wherein the determination module determines, as the assignment destination of the another combination of two or more time-series data after the elapse of the first time period, the another one of the sign detection processes to be executed in parallel with the one of sign detection processes.

11. A detection method to be executed by a computer comprising a processor configured to execute a program and a memory configured to store the program executed by the processor, the detection method comprising:
acquiring, by the processor, a plurality of time-series data on a detection target;
setting, by the processor, based on a first time period in which the plurality of time-series data acquired in the acquiring exist, a plurality of second time periods as inspection ranges;
selecting, by the processor, a combination of two or more time-series data from among the plurality of time-series data; and
calculating, by the processor, a correlation coefficient in each of the plurality of second time periods set in the setting for the combination of two or more time-series data selected in the selecting.

12. A non-transitory recording medium readable by a processor, which is configured to store a program to be executed by the processor, the recording medium having stored thereon a detection program for controlling the processor to execute the procedures of:
acquiring a plurality of time-series data on a detection target;
setting, based on a first time period in which the plurality of time-series data acquired in the acquisition procedure exist, a plurality of second time periods as inspection ranges;
selecting a combination of two or more time-series data from among the plurality of time-series data; and
calculating a correlation coefficient in each of the plurality of second time periods set in the setting procedure for the combination of two or more time-series data selected in the selection procedure.
